(19) United States
(12) Patent Application Publication
(10) Pub. No.: US 2006/0278080 A1
(43) Pub. Date: Dec. 14, 2006

(54) Negative ion air purifier

(76) Inventors: Chuang Li, Shenzhen (CN); Yong Du, Shenzhen (CN); Hong Li, Shenzhen (CN)

Correspondence Address: KNOBBE MARTENS OLSON & BEAR LLP, 2040 MAIN STREET, FOURTEENTH FLOOR, IRVINE, CA, 92614, US

(21) Appl. No.: 11/376,003

(22) Filed: Mar. 15, 2006

Related U.S. Application Data
(60) Provisional application No. 60/684,553, filed on May 26, 2005.

(51) Int. Cl. B03C 3/68

(52) U.S. Cl. 96/18

(57) ABSTRACT

The utility model discloses a negative ion air purifier, comprising an electrostatic field-generating module and a voltage boost circuit. The voltage output end of the voltage boost circuit connects with the voltage input end of the electrostatic field-generating module. Said electrostatic field-generating module includes anodes and cathodes that are arrange alternately and equidistantly. A frequency conversion and voltage regulation module is further added, whose voltage signal sampling end connects with the voltage output end of said voltage boost circuit and whose control end connects with the voltage signal input end of said voltage boost circuit, thus making the device adapted to the fluctuation of the mains electricity between 180V to 240V and perform its functions steadily, and overcoming the disadvantages of existing products, such as the proneness to burnout and stop, unstable release of the ion flow, big noise and the difficulty in keeping effective.

### CROSS-REFERENCE TO RELATED APPLICATIONS

This application claims the benefit of U.S. Provisional Application No. 60/684,553 filed May 26, 2005, which is incorporated by reference herein in its entirety.

### BACKGROUND OF THE INVENTION

1. Field of the Invention

The present invention relates to an air-purifying device.

2. Description of the Related Art

High-concentration of negative ions in the air help people concentrate their attention, refresh their spirit and enhance their work efficiency. Negative ions can improve the functions of the respiratory system, immune system, nervous system and hematopoietic system of human beings. It has been proved that negative ions can effectively activate oxygen molecules in the air and make them active and thus easier to be absorbed by human bodies. After absorbing negative ions, the lung can absorb additional 20% of oxygen and discharge additional 15% of carbon dioxide, thus accelerating the metabolism, enhancing disease resistance and improving sleep quality. Negative ions can absorb various viruses and bacteria, causing changes in their organs or transfers of the energy and resulting in death of the viruses and bacteria. Since negative ions can purify air and improve air quality, negative ion air purifying devices or air purifiers are popular.

The principle of a negative ion air purifier is as follows: a metal tip corona discharges under high voltage ionize the air, producing large amounts of negative ions. The high voltage electrostatic field is formed by multiplying the mains electricity with a voltage boost circuit to high voltages of about 5000V at anode and 9000V at cathode and applying them on tungsten filaments and metal dust collecting plates, respectively. There are three groups of tungsten filaments and metal dust collecting plates in all, arranged in the shape of “!!!”, and in a certain space scope between the two is formed an electrostatic field that produces ion winds with the air under the effect of the high voltage electrostatic field, and the dust removal effect is obtained by using the metal- dust-collecting plates as the cathode to capture small particles with electric charge. Simultaneously the electrostatic field will produce ozone of certain concentration. The production rate of air negative ions and ozone are in direct proportion to the voltage. The normal working voltage is about 5000V at anode and about 9000V at cathode. If the voltage is too low, e.g. anode falls to about 3000V and cathode falls to about 7000V, the power is not enough, and the device is not able to serve its intended function and the effect is not obvious. However, if voltage difference between anode and cathode is too big, although the production rate of negative ions is high, burnouts could be induced, and the ozone concentration and noise will be too high to the detriments of people's health. In actual operation, due to the extreme instability of the mains electricity that normally fluctuates between 180V-240V, said problems frequently occur.

### SUMMARY OF THE INVENTION

A negative ion air purifier that includes an electrostatic field-generating module and a voltage boost circuit is provided. The voltage output end of the voltage boost circuit is connected to the voltage input end of the electrostatic field-generating module. The electrostatic field-generating module includes anodes and cathodes, which are arranged alternately and equidistantly. The air purifier also includes a frequency-converting-plus-voltage-regulating module, of which the voltage-signal sampling end is connected to the voltage output end of the voltage boost circuit and the control end is connected to the voltage-signal input end of the voltage boost circuit.

The frequency-converting-plus-voltage-regulating module includes a voltage-signal sampling circuit, a main control circuit MCU and a PWM output rectification circuit. The input end of the voltage-signal sampling circuit is connected to the voltage output end of the voltage boost circuit, and the other end thereof is connected to the main control circuit. One end of the PWM output rectification circuit is connected to the PWM signal output end of the main control circuit, and the other end thereof is connected to the voltage input end of the voltage boost circuit. The voltage-signal sampling circuit includes a RC filter circuit. The RC filter circuit has a potentiometer VR1, which is connected between the voltage output end of the voltage boost circuit and the ground.

The voltage boost circuit includes a first voltage boost circuit and a second voltage boost circuit. The voltage-signal sampling end of the frequency-converting-plus-voltage-regulating module is connected to the voltage output end of the first voltage boost circuit, and the control end of the frequency-converting-pius-voltage-regulating module is connected to the voltage-signal input end of the second voltage boost circuit.

In the negative ion air purifier, the anodes and cathodes are arranged alternately and equidistantly. The electrostatic field-generating module includes four tungsten filaments and three pieces of metal-dust-collecting plates. The metal-dust-collecting plates are arranged vertically in parallel. The tungsten filaments are uniformly distributed and alternately arranged between the metal-dust-collecting plates, which can be made from a wide variety of material, including stainless steel and aluminum alloy.

The negative ion air purifier produces following favorable effects:
1. Due to the addition of the frequency-converting-plus-voltage-regulating circuit, the negative ion air purifier can adapt to mains electricity fluctuations and steadily perform its function to overcome the disadvantages of currently existing products, such as proneness to burnout and stop, unstable release of ionic flow, and difficulty in achieving effectiveness.
2. Due to the use of MCU as a main control circuit, the negative ion air purifier enjoys a high degree of integration, which is beneficial for steady mass production and saving the spaces occupied by the circuits.
3. The adoption of the structure of three pieces of metal-dust-collecting plates and four pieces of tungsten filaments arranged alternately enlarges the space of electrostatic field and increases the rate of ionic flow. Thus, the effect of air purification such as odor elimination, dust removal, dust absorption, sterilization, disinfection, etc is enhanced.
4. The metal-dust-collecting plates are made into the shape of plate from stainless steel tubes employing a precision forming technology. As a result, their functions are better than those of ordinary plates, more favorable for removing dust. The dust-collecting plate group has higher strength and costless. The sources and ways of obtaining the material are broader, while the manufacture process is simpler. The quality is easier to control, while the total cost is lower.
5. The metal-dust-collecting plates are formed in one step directly from the latest aluminium alloy, which are then processed by polishing and special anti-oxidation. Thus, their functional effect is better. The dust-collecting plate group does not change the shape easily by washing, has better electrical conductivity, and cost much less. Materials for dust-collecting plates are inexpensive, sources and ways of obtaining of the materials are broad. In addition, the weight is lighter. The manufacture process is simple and easy, while the quality control is easier.

### BRIEF DESCRIPTION OF THE DRAWINGS

FIG. 1 shows a circuit diagram of one embodiment.

FIG. 2 shows an exploded view of the air purifier of one embodiment.

FIGS. 3a, 3b and 3c show structural schematic diagrams of a dust-collecting plate of stainless steel tube in one embodiment.

FIGS. 4a, 4b and 4c show structural schematic diagrams of a dust-collecting plate made of aluminium alloy in one embodiment.

FIG. 5 shows a structural schematic diagram of a metal-dust-collecting plate unit in one embodiment.

FIG. 6 shows a schematic diagram of the overall structure of one embodiment.

### DETAILED DESCRIPTION OF THE INVENTION

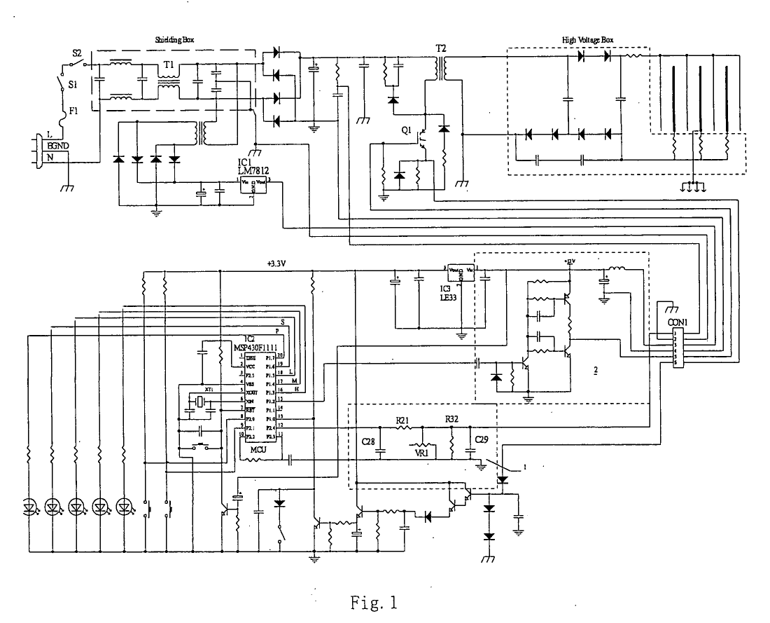

As shown in FIG. 1, the voltage boost circuit for providing high voltage includes a first voltage boost circuit with a transformer T1 and a second voltage boost circuit with a transformer T2. The mains electricity, after being first boosted in the transformer T1 and then rectified and filtered, is provided to the transformer T2 for the second boost. A frequency-converting-plus-voltage-regulating module includes a voltage sampling circuit 1, a main control circuit MCU and a PWM output rectification circuit 2. MSP430 can be adopted for the main control circuit MCU. The voltage sampling circuit detects in real time the output voltage of the voltage boost circuit and feeds it back to the main control circuit. The main control circuit outputs PWM-modulated pulses accordingly, which, after being rectified and filtered, controls the waveform of input voltage at the transforner's primary, thereby controlling the output voltage at the transformer's secondary. The voltage sampling circuit 1 includes a resistance R21, a potentiometer VR1, capacitances C28 and C29, and a resistance R32. One end of R21 is connected to the secondary output end of the transformer T1, and the other end thereof is connected to pin 12 of the sample signal input end of the main control circuit MCU. C28 is connected between pin 12 and ground. VR1, C29 and R32 are connected in parallel between one end of R21 and ground. The voltage sampling circuit detects in real time the output voltage of T1, filters voltage-waves and provides them to MCU, wherein the potentiometer VR1 is adjustable to regulate the frequency of filtered waves. Based on the duty cycle of the output voltage of T1, MCU outputs PWM-modulated pulses, which passes the PWM output rectification circuit 2. The signal output end of the PWM output rectification circuit is connected to the control electrode of a switching transistor Q1 that is connected in series to the primary coil of the transformer T2, and via adjusting the input harmonic voltage waves at the T2 primary, the purpose of controlling output voltage at the T2 secondary is achieved. When the mains electricity fluctuates, the added frequency-converting-plus-voltage-regulating module can perform constant voltage regulation automatically, eventually stabilizing the high voltage supplied to the tungsten filaments as anode and metal-dust-collecting plates as cathode by the voltage boost circuit at a predetermined value, hence steadily release of the ionic flow and production of ozone of proper concentration.

Utilizing the main control circuit MCU of the above-mentioned frequency-converting-plus-voltage-regulating module, various functions can further be performed. A working mode selection circuit can further be included, providing power options of high, medium and low level, or other working modes. A malfunction detection and alert circuit can also be provided, which provides acoustic or optical alarm for malfunctions or other indications via real-time detection of various working modes. For example, when it is detected that there are too much dust on stainless steel dust-collecting plates, a red light flashes, indicating to the user to clean or change the dust-collecting plates.

The frequency-converting-plus-voltage-regulating module can also produce PWM pulses with a switching transistor like thyristor.

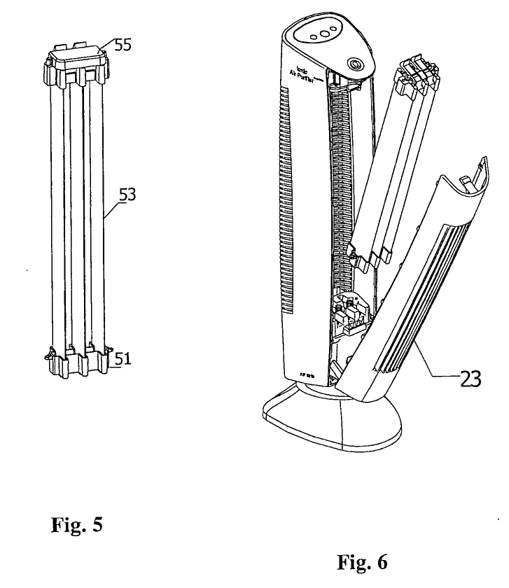

FIG. 2 is an exploded view of the air purifier of one embodiment, which shows that, differing from the three pieces of tungsten filaments and three pieces of stainless steel plates arranged in parallel in the shape of “!!!” in prior art, the metal-dust-collecting plates 53 in this embodiment are arranged vertically in parallel, with tungsten filaments 24 inserted in between. The metal-dust-collecting plates 53 and tungsten filaments 24 are arranged alternately and distributed uniformly. Four pieces of tungsten filaments 24 and three pieces of metal-dust-collecting plates 53 are arranged alternately in the shape of “.|.|.|.” in one embodiment, which makes the structure more compact. Also the enlarged space of the electrostatic field and the uniform distribution of the electric field help to speed up the flow rate of ionic winds and improve dust-removal effect of, which is significantly enhanced compared with the original structure under equal power. In the metal dust-collecting group as shown in FIG. 5, the metal-dust-collecting plates 53 are embedded between an upper dust-collecting plate frame 55 and a lower dust-collecting plate frame 51, thus forming a whole unit, which is then fixed between an upper supporting frame 15 and a lower supporting frame 26, providing the convenience for disassembly. As shown in FIG. 6, the upper part of a front window cover 23 can be flicked open, facilitating disassembly and changes or cleaning of the metal-dust-collecting plate group.

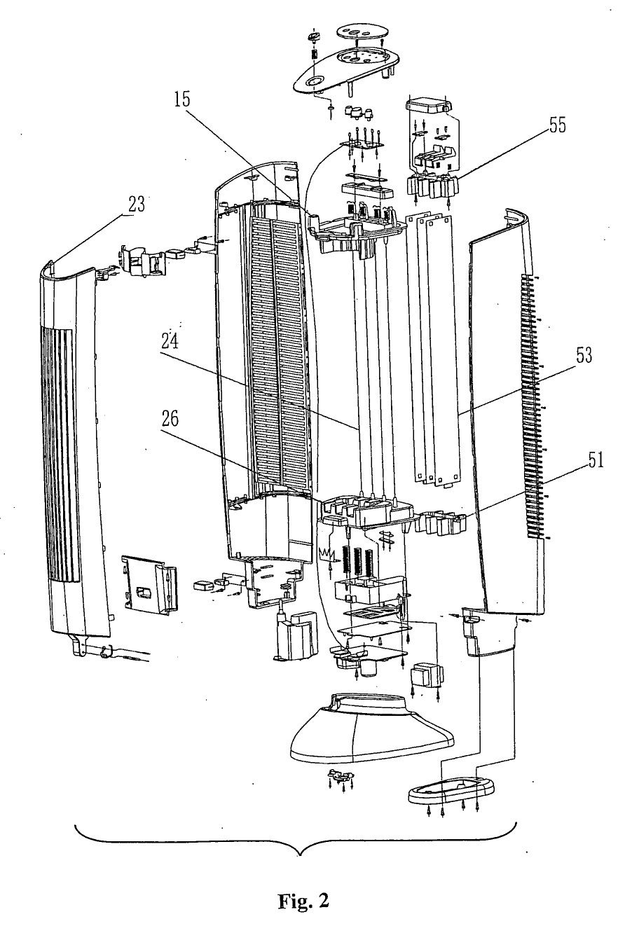

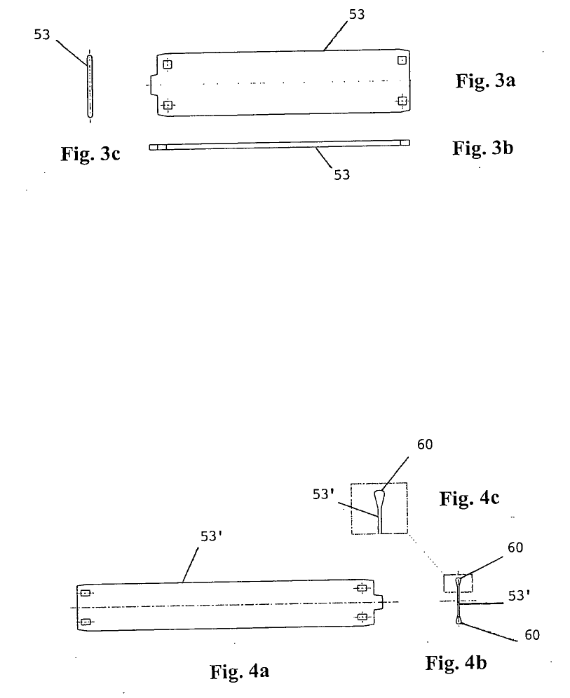

FIGS. 3a-3c are structural schematic diagrams of a metal-dust-collecting plate 53 adopting a stainless steel tube in one embodiment. The metal-dust-collecting plate 53 is made into the shape of plate from a stainless steel tube with precision forming technology, thus has better effect than that of an ordinary plate. Because sources and means of obtaining material is broad, the manufacture process is simple, quality control is easy, the total cost is significantly decreased.

FIGS. 4a-4c are structural schematic diagrams of a metal-dust-collecting plate 53′ adopting an aluminium alloy tube in one embodiment. The metal-dust-collecting plate 53′ is formed in one step directly from the latest aluminium alloy, and then processed by polishing and special anti-oxidation. This aluminium alloy plate is provided with protruding edges 60 along its two vertical side.

While the present invention has been shown and described with particular references to a number of preferred embodiments thereof, it should be noted that various other changes or modifications may be made without departing from the scope of the present invention.

What is claimed is:

1. A negative ion air purifier, comprising (1) a high voltage electrostatic field-generating module including a voltage input end; (2) a voltage boost circuit including a voltage signal input end and a voltage output end, said voltage output end connected to said voltage input end of said electrostatic field-generating module, said electrostatic field-generating module including anodes and cathodes; and (3) a frequency-converting-plus-voltage-regulating module including a voltage signal sampling end and a control end, said voltage signal sampling end connected to said voltage output end of said voltage boost circuit, and said control end connected to said voltage signal input end of said voltage boost circuit.

2. The negative ion air purifier of claim 1, wherein said frequency-converting-plus-voltage-regulating module comprises a voltage signal sampling circuit including an input end, a main control circuit including a PWM signal output end, and a PWM output rectification circuit including an end; wherein said input end of said voltage signal sampling circuit is connected to said voltage output end of said voltage boost circuit, and the other end of said voltage signal sampling circuit is connected to said main control circuit, and wherein said end of said PWM output rectification circuit is connected to said PWM signal output end of said main control circuit, and the other end of said PWM output rectification circuit is connected to said voltage input end of said voltage boost circuit.

3. The negative ion air purifier of claim 1, wherein said voltage boost circuit includes a first voltage boost circuit having a voltage output end and a second voltage boost circuit having a voltage signal input end, said voltage signal sampling end of said frequency-converting-plus-voltage-regulating module is connected to said voltage output end of said first voltage boost circuit, and said control end of said frequency-converting-plus-voltage-regulating module is connected to said voltage signal input end of said second voltage boost circuit.

4. The negative ion air purifier of claim 2, wherein said voltage signal sampling circuit includes a RC filter circuit, said RC filter circuit includes a potentiometer (VR1), which is connected between said voltage output end of said voltage boost circuit and ground.

5. The negative ion air purifier of claim 1, wherein said anodes and cathodes are arranged alternately and equidistantly.

6. The negative ion air purifier of claim 1, wherein said electrostatic field-generating module includes four pieces of tungsten filaments and three pieces of metal-dust-collecting plates, said metal-dust-collecting plates is arranged vertically in parallel, and said metal-dust-collecting plates is uniformly distributed and alternately arranged among said tungsten filaments.

7. The negative ion air purifier of claim 6, wherein said three pieces of metal-dust-collecting plates are made of stainless steel tubes being pressed into plate shape.

8. The negative ion air purifier of claim 6, wherein said three pieces of metal-dust-collecting plates are made of aluminium alloy material being pressed into plates and processed by anti-oxidation.

9. The negative ion air purifier of claim 8, wherein said aluminum alloy plates are each provided with protruding edges along two vertical sides thereof.
